(19) United States
(12) Patent Application Publication
(10) Pub. No.: US 2025/0196144 A1
(43) Pub. Date: Jun. 19, 2025

(54) Methods, Systems, and Device for Bead Dispersion

(71) Applicant: IDEXX Laboratories, Inc., Westbrook, ME (US)

(72) Inventors: Asanterabi Malima, Westbrook, ME (US); Claire Tempest, Westbrook, ME (US); Murthy Yerramilli, Westbrook, ME (US)

(21) Appl. No.: 18/927,384

(22) Filed: Oct. 25, 2024

Related U.S. Application Data
(60) Provisional application No. 63/593,200, filed on Oct. 25, 2023.

(51) Int. Cl. B01L 3/00

(52) U.S. Cl. CPC B01L 3/502784; B01L 2200/0647; B01L 2300/021; B01L 2300/027; B01L 2300/0645; B01L 2300/12; B01L 2400/0415

(57) ABSTRACT

A method for dispersing a plurality of particles of a droplet on a surface of a cartridge is disclosed. The method includes transporting, by applying a first electrical current to a first plurality of electrodes of the cartridge, the droplet on the surface of the cartridge at a predetermined transport speed, wherein the first plurality of electrodes is configured to transport the droplet on the surface of the cartridge along a non-linear path and manipulating, by applying a second electrical current to a second plurality of electrodes of the cartridge, the droplet on the surface of the cartridge.

### RELATED APPLICATION

This application claims priority to U.S. Provisional Application No. 63/593,200 filed Oct. 25, 2023, which is incorporated herein by reference in its entirety.

### FIELD OF THE DISCLOSURE

The present disclosure involves systems and methods for dispersing a plurality of particles of a droplet on a surface of a cartridge. Namely, devices and methods of the disclosure transport and/or manipulate the droplet and/or the plurality of particles on a surface of the cartridge to ensure that the plurality of particles are evenly dispersed throughout the droplet and that any unwanted physical interactions between any two or more particles of the plurality of particles (e.g., clumping) is minimized. By dispersing the particles throughout the droplet, any analysis of the droplet and/or components thereof (e.g., the plurality of particles) may be improved.

### BACKGROUND

Assays (including immunoassays) and other analytical evaluations (e.g., polymerase chain reaction (PCR) tests) can be conducted on one or more portions of a sample utilizing a variety of different methods, including by utilizing a plurality of particles (e.g., paramagnetic, bar-coded beads) and other components of a droplet of the solution containing the sample to assist in performing the assays and other analytical evaluations.

Conventionally, these assays and analytical evaluations have been conducted on preconfigured and prefabricated testing platforms. One such platform are preconfigured cartridges that utilize a plurality of electrodes to transport individual droplets of a liquid on a surface of the cartridge along one or more paths defined by the plurality of electrodes on one or more surfaces of one or more materials, including a printed circuit board (PCB), semiconductor photolithography, conductive patterning on glass, conductive patterning on ceramic, and/or conductive patterning on plastic, among other possibilities. Such techniques are often referred to as electrowetting on dielectric (“EWOD”).

In some examples, a plurality of particles (e.g., paramagnetic, bar-coded beads), can be suspended within a solution on the surface of an EWOD cartridge that can be used for testing and identification of components in the solution and/or a portion thereof (e.g., a particular type of paramagnetic, bar-coded bead). To increase the accuracy of assay test results, it is desirable to, prior to testing, ensure that the plurality of particles (e.g., paramagnetic, bar-coded beads) are properly dispersed throughout the solution and properly transported and/or manipulated (e.g., immobilized) during the mixing of the components of the assay, as well as during readings of the resultant solution.

When a sample resides in a prepared droplet of solution for too long prior to testing, the homogeneity and number of particles throughout the prepared droplet may be inconsistent and any resultant analysis of the droplet (or components therein) may be inaccurate. Further, this inconsistency may be due, at least in part, to the particles becoming less homogenized and/or dispersed throughout the droplet (e.g., by settling to the bottom and/or edges of the droplet, clumping together or both, among other potential issues). Accordingly, improved preparations of the droplet and the components thereof are subject to variability between testing runs and/or operators and, thus, degrade the accuracy and precision of any associated testing results (e.g., assay results).

### SUMMARY

In an example, a method for dispersing a plurality of particles of a droplet on a surface of a cartridge is disclosed. The method comprises transporting, by applying a first electrical current to a first plurality of electrodes of the cartridge, the droplet on the surface of the cartridge at a predetermined transport speed, wherein the first plurality of electrodes is configured to transport the droplet on the surface of the cartridge along a non-linear path and manipulating, by applying a second electrical current to a second plurality of electrodes of the cartridge, the droplet on the surface of the cartridge.

In another example, a non-transitory computer-readable medium is described, having stored thereon program instructions that, upon execution by a controller cause a controller to perform a set of operations. The set of operations comprises transporting, by applying a first electrical current to a first plurality of electrodes of a cartridge, a droplet on the surface of the cartridge at a predetermined transport speed, wherein the first plurality of electrodes is configured to transport the droplet on the surface of the cartridge along a non-linear path, and wherein the droplet comprises the plurality of particles and manipulating, by applying a second electrical current to a second plurality of electrodes of the cartridge, the droplet on the surface of the cartridge.

In another example, a cartridge comprising a first plurality of electrodes and a second plurality of electrodes is described. The cartridge further comprises a first surface for transporting, by applying a first electrical current to the first plurality of electrodes of the cartridge, a droplet on the surface of the cartridge at a predetermined transport speed, wherein the first plurality of electrodes is configured to transport the droplet on the surface of the cartridge along a non-linear path, and wherein the droplet comprises the plurality of particles and a second surface for manipulating, by applying a second electrical current to a second plurality of electrodes of the cartridge, the droplet on the surface of the cartridge.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2A illustrates a cartridge, according to an example embodiment.

FIG. 2B illustrates the cartridge of FIG. 2A, according to an example embodiment.

FIG. 2C illustrates the cartridge of FIGS. 2A-2B, according to an example

embodiment.

FIG. 2D illustrates the cartridge of FIGS. 2A-2C, according to an example embodiment.

FIG. 3A illustrates a droplet of prepared solution containing a plurality of particles according to an example embodiment.

FIG. 3B illustrates an image of the droplet of prepared solution containing a plurality of particles of FIG. 3A, according to an example embodiment.

FIG. 3C illustrates a composite image of the droplet of prepared solution containing a plurality of particles of FIGS. 3A and 3B and an associated graphical user interface, according to an example embodiment.

FIG. 4 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the disclosure is directed to devices and methods for transporting and manipulating droplets of a solution containing samples and a plurality of particles (e.g., one or more types of paramagnetic, bar-coded beads) containing one or more identifying features (such as a unique bar code, a responsive wavelength (e.g., in PCR testing), a color, a shape, an alphanumeric symbol, and/or the like). These particles include one or more of the following: microbeads, microparticles, micropellets, microwafers, microparticles containing one or more identifying features (such as a bar code, a responsive wavelength (e.g., in PCR testing), a color, a shape, an alphanumeric symbol, and/or the like), paramagnetic microparticles, paramagnetic microparticles containing one or more bar codes, and/or beads containing one or more bar codes. Moreover, the particles may be magnetic or paramagnetic. Particles suitable for use in the disclosure are capable of attachment to other substances such as derivatives, linker molecules, proteins, nucleic acids, or combinations thereof. The capability of the particles to be attached to other substances can result from the particle material as well as from any further surface modifications or functionalization of the particle. The particles can be functionalized or be capable of becoming functionalized in order to covalently or non-covalently attach proteins, nucleic acids, linker molecules or derivatives as described herein.

For example, the surface of these particles (e.g., paramagnetic, bar-coded beads), can be modified or functionalized with amine, biotin, streptavidin, avidin, protein A, sulfhydryl, hydroxyl and carboxyl. These particles may be spherical or other shapes, may be light transmissive and may be digitally coded such as for example, by an image that provides for high contrast and high signal-to-noise optical detection to facilitate identification of the bead. To the extent an image is present, the image may be implemented by a physical structure having a pattern that is partially substantially transmissive (e.g., transparent, translucent, and/or pervious to light), and partially substantially opaque (e.g., reflective and/or absorptive to light) to light. The pattern of transmitted light is determined (e.g., by scanning or imaging), and the code represented by the image on the coded bead can be decoded. Various code patterns, such as circular, square, or other geometrical shapes, can be designed as long as they can be recognized by an optical decoder. Examples of these one or more types of particles may be found at: U.S. Pat. Nos. 7,745,091, 8,148,139, and 8,614,852.

Additionally or alternatively, these particles (e.g., paramagnetic, bar-coded beads) may comprise one or more materials, including one or more of the following: glass, polymers, polystyrene, latex, elemental metals, ceramics, metal composites, metal alloys, silicon, or of other support materials such as agarose, ceramics, glass, quartz, polyacrylamides, polymethyl methacrylates, carboxylate modified latex, melamine, and sepharose, and/or one or more hybrids thereof. In particular, useful commercially available materials include carboxylate modified latex, cyanogen bromide activated sepharose beads, fused silica particles, isothiocyanate glass, polystyrene, and carboxylate monodisperse microspheres. Furthermore, these particles also comprise one or more specific shapes, dimensions, and/or configurations and may be modified for one or more specific uses. For example, these particles (e.g., paramagnetic, bar-coded beads) may be a variety of sizes from about 0.1 microns to about 100 microns, for example about 0.1, 0.5, 1.0, 5, 10, 20, 30, 40 50, 60, 70, 80 90 or 100 microns. In a further aspect, these particles may be surface modified and/or functionalized with biomolecules for use in biochemical analysis.

The particles of the disclosure may be used in various homogenous, sandwich, competitive, or non-competitive assay formats to generate a signal that is related to the presence or amount of an analyte in a test sample. The term “analyte,” as used herein, generally refers to the substance, or set of substances in a sample that are detected and/or measured, either directly or indirectly. In various aspects the assays of the disclosure, examples include sandwich immunoassays that capture an analyte in a sample between a binding member (e.g., antibody) attached to the particles and a second binding member for the analyte that is associated with a label. In another example embodiment, the binding member on the particles may be an antigen (e.g., protein) that binds an antibody of interest in a patient sample in order to capture the antibody on the particle. The presence of the antibody can then be detected with a label conjugated to a second binding member specific for an antibody. The second binding member attached to the label may be the antigen conjugated to the label or the binding member may itself be an antibody (e.g., anti-species antibody) that is conjugated the label. In example embodiments, these characteristics may be referred to herein as a “unique identifying feature” and/or “parameter” of the particles and/or of droplet in which the particles reside. Other examples are possible. For example, the particles may also bind to a fluorescent tag or label, which may present a “unique identifying feature” and/or “parameter” of particles to which the fluorescent tag or label might bind and emit one or more responsive signals (e.g., a light signal) under one or more appropriate excitation stimuli (e.g., a fluorescent and/or ultraviolet lighting).

In another example embodiment, the testing protocols of the disclosure are assays, including competitive immunoassays for detection of antibody in the sample. A competitive immunoassay may be carried out in the following illustrative manner. A sample, from an animal's body fluid, potentially containing an antibody of interest that is specific for an antigen, is contacted with the antigen attached to the particles and with the anti-antigen antibody conjugated to a detectable label. The antibody of interest, present in the sample, competes with the antibody conjugated to a detectable label for binding with the antigen attached to the particles. The amount of the label associated with the particles can then be determined after separating the unbound antibody and the label. The signal obtained is inversely related to the amount of antibody of interest present in the sample.

In an alternative example embodiment of a competitive sample, an animal's body fluid, potentially containing an analyte, is contacted with the analyte conjugated to a detectable label and with an anti-analyte antibody attached to the particles. The antigen in the sample competes with analyte conjugated to the label for binding to the antibody attached the particles. The amount of the label associated with particles can then be determined after separating unbound antigen and label. The signal obtained is inversely related to the amount of analyte present in the sample.

Antibodies, antigens, and other binding members may be attached to the particles or to the label directly via covalent binding with or without a linker or may be attached through a separate pair of binding members as is well known (e.g., biotin:streptavidin, digoxigenin:anti-digoxiginen). In addition, while the examples herein reflect the use of immunoassays, the paramagnetic, bar-coded beads and/or particles and methods of the disclosure may be used in other receptor binding assays, including nucleic acid hybridization assays, that rely on immobilization of one or more assay components to a solid phase.

Assays using these solutions are often conducted after a series of agitation, assembly, and/or mixing events. In practice, these particles (particularly if they are paramagnetic, bar-coded beads) may bind together in the solution (often referred to as “clumping”) or bind and/or settle on the bottom or sides of the solution and/or a surface or container with which the solution is in contact. This binding and/or clumping may result in an inconsistent dispersion of the particles (e.g., paramagnetic, bar-coded beads and/or particles) in the solution. When these particles clump together, they may not be accurately identified or accounted for in the assay.

For example, to help address these issues, a cartridge may utilize a plurality of electrodes that facilitate transportation of individual droplets of a liquid on a surface of the cartridge and/or one or more components thereof. To do so, in one example embodiment, the cartridge surface may comprise dielectric materials that transport individual droplets along one or more paths defined by the plurality of electrodes on one or more surfaces of one or more materials, including (PCB), semiconductor photolithography, conductive patterning on glass, conductive patterning on ceramic, and/or conductive patterning on plastic, among other possibilities. In example embodiments, the dielectric materials may comprise a hydrophobic material, layer, and/or coating disposed on the surface of the PCB and/or plurality of electrodes, the combination of which is referred to herein as the “dielectric surface” and/or a “path” or “paths” along the dielectric surface.

In some embodiments, transportation of the droplets on the cartridge surface can be controlled by a controller and/or other computing devices to create a programmable fluidic path which can be used in number of ways (e.g., to facilitate the performance of an assay and/or immunoassay). Further, because the fluidic movements of the droplets are controlled by a controller and/or other computing device, and programmable, assay protocols and subparts thereof can be finely controlled to meet the needs of the solution mixing, particle assembly, and/or assay, among other parameters.

For example, in some example embodiments, the transportation of the droplets and/or or components thereof may be transported and/or otherwise controlled by a plurality of electrodes that receive an electrical current that mobilize the droplet along one or more specific fluidic paths on the surface of the cartridge (e.g., a dielectric surface of the cartridge). In some examples, the plurality of electrodes may receive an alternating electrical current (“AC”) at a particular frequency during transportation of the droplet. For example, this particular frequency may be one or more of a variety of frequencies from about 10 hertz to about 100 hertz, for example about 10, 20, 30, 40 50, 60, 70, 80, 90 or 100 hertz. In some examples, the plurality of electrodes may receive an alternating electrical current at a particular voltage during transportation of the droplet. For example, this particular voltage may be one or more of a variety of voltages from about 10 volts to about 1000 volts, for example about 10, 50, 100, 200, 300, 400 500, 600, 700, 800, 900, or 1000 volts. Other examples are possible.

For example, in some embodiments, the droplets and/or or components thereof may be transported at a particular transport speed along one or more specific fluidic paths on the surface of the cartridge. In some examples, the plurality of electrodes may receive a particular alternating electrical current at a particular frequency (e.g., 30 hertz) that causes the droplet to be transported along the surface of the cartridge such that the droplet is moving at a particular speed (referred to herein as “transport speed”) such that the droplet does not reside in one location on the cartridge surface for more than a threshold amount of time during transportation of the droplet (referred to herein as “hold time”). For example, this threshold amount of hold time may be from about 10 milliseconds to about 300 milliseconds, for example about 10, 20, 30, 40 50, 60, 70, 80, 90, 100, 110, 120, 130, 140, 150, 160, 170, 180, 190, 200, 210, 220, 230, 240, 250, 260, 270, 280, 290, or 300 milliseconds. Other examples are possible.

For example, in some embodiments, the droplets and/or or components thereof may be transported along one or more specific fluidic paths on the surface of the cartridge. In some examples, the plurality of electrodes may cause the droplet to be transported along a first, substantially linear fluidic path on the surface of the cartridge at a first transport speed and then cause the droplet to be transported along a second, substantially linear fluidic path on the surface of the cartridge that is of a specific orientation to the first substantially linear fluidic path at a second transport speed such. In example embodiments, if the droplet does not reside in one location on the cartridge surface for more than a threshold amount of time, then the kinetics of being transported along the first and/or second substantially linear fluidic paths may impart a mechanical action on the droplet and/or the components thereof during transportation of the droplet. For example, in some embodiments, if the first and second substantially linear fluidic paths are perpendicular to each other, and the transport speed of the droplet is the same or similar along each fluidic path, then the droplet and the components thereof will be imparted with a mechanical action caused by the momentum of the droplet and/or the components taking a 90 degree turn during transportation of the droplet. This mechanical action may cause, among other things, the components of the droplet (e.g., a plurality of particles in the droplet) to move and/or otherwise disperse throughout the droplet. Other examples are possible.

In some examples, the plurality of electrodes may cause the droplet to be transported along a first, substantially linear fluidic path on the surface of the cartridge at a first transport speed and then cause the droplet be transported along a second, non-linear fluidic path on the surface of the cartridge that is of a specific configuration and/or orientation to the first substantially linear fluidic path at a second transport speed. For example, in some embodiments, if the first substantially linear fluidic path is connected to a particularly configured second, substantially rectangular fluidic path, and the transport speed of the droplet is the same or similar along each fluidic path, then the droplet and the components thereof will be imparted with a mechanical action caused by the momentum of the droplet and/or the components during transportation of the droplet. This mechanical action may cause, among other things, the components of the droplet (e.g., a plurality of particles in the droplet) to move and/or otherwise disperse throughout the droplet. Other example non-linear paths include: substantially square paths, substantially circular paths, substantially triangular paths, substantially pentagonal paths, substantially hexagonal paths, substantially heptagonal paths, substantially octagonal paths, and substantially decagonal paths, among others. Other examples are possible.

For example, in some example embodiments, the manipulation of the droplets and/or or components thereof may be manipulated and/or otherwise controlled by a plurality of electrodes that receive an electrical current that manipulates (e.g., immobilizes) the droplet at one or more specific locations along the fluidic paths on the surface of the cartridge (e.g., a dielectric surface of the cartridge). In some examples, the plurality of electrodes may receive a direct electrical current (“DC”) that immobilizes the droplet and/or the components thereof during testing and/or analysis. In some examples, particularly if the droplet and/or the components thereof have magnetic or paramagnetic properties, if plurality of electrodes receive a direct electrical current, then the droplet and/or the components may align and/or otherwise be oriented in one or more particular orientations during testing and/or analysis (e.g., due to the DC creating a magnetic field in one or more particular directions). In some examples, the plurality of electrodes may also receive an alternating electrical current (“AC”) at a particular frequency during manipulation of the droplet. For example, this particular frequency may be one or more of a variety of frequencies from about 10 hertz to about 100 hertz, for example about 10, 20, 30, 40 50, 60, 70, 80, 90 or 100 hertz. In some examples, the plurality of electrodes may receive a direct and/or alternating electrical current at a particular voltage during manipulation of the droplet. For example, this particular voltage may be one or more of a variety of voltages from about 10 volts to about 1000 volts, for example about 10, 50, 100, 200, 300, 400 500, 600, 700, 800, 900, or 1000 volts.

For example, in some embodiments, the droplets and/or or components thereof may be manipulated for a particular amount of time at one or more locations on the surface of the cartridge. In some examples, this threshold amount of hold time at a particular location may be from about 1000 milliseconds to about 6000 milliseconds, for example about 1000, 1050, 2000, 2050, 3000, 3050, 4000, 4050, 5000, 5050, or 6000 milliseconds. Other examples are possible.

In one example embodiment, there may be a plurality of electrodes having different sizes, e.g. containing a larger electrode and a smaller electrode. The plurality of electrodes may cause the droplet to be transported from the larger electrode to the smaller electrode. In this example, the threshold amount of hold time at the larger electrode is greater than the threshold amount of hold time on the smaller electrode or electrodes. For example, the threshold amount of hold time on the larger electrode can be from about 100 milliseconds to about 3000 milliseconds, for example about 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, or 3000 milliseconds as compared to examples of threshold amount of hold time on the smaller electrodes of from about 50 milliseconds to about 300 milliseconds, for example about 50, 60, 70, 80, 90, 100, 110, 120, 130, 140, 150, 160, 170, 180, 190, 200, 210, 220, 230, 240, 250, 260, 270, 280, 290, or 300 milliseconds. In example embodiments, larger threshold amounts of hold time on the larger electrodes prevents splitting/pinning of the droplet.

In an example embodiment, in addition to controlling the transportation and/or manipulation (e.g., immobilizing) of the droplet on the surface of the cartridge, various antibodies, antigens, and/or other components may also be controlled, mixed, transported, and/or immobilized on the surface of the cartridge. Using this programmable protocol, antibodies, antigens, and/or other components may be adhered onto one or more surfaces of the plurality of particles (e.g., paramagnetic, bar-coded beads), which are referred to herein as the “assembled particles”. In a further aspect, one or more analyses may be performed on the assembled particles on the surface of the cartridge. In this regard, a user of the cartridge can perform complicated, often multi-step protocols, which are often spread over several machines and devices at various stages of the multi-step protocols, in a single cartridge and a single instrument/device. In one example embodiment, a multiplex multiple analyte targets in a single reaction may be performed on a droplet on the surface of the cartridge detailed above, instead of using multiple devices (e.g., shaker plates, pipettes, vials, plates with multiple wells, plate readers, cameras, etc.). In one example embodiment, a multiplex multiple analyte targets in a single reaction may be performed on a droplet in a portion of the surface of the cartridge comprising a single electrode. Other examples are possible.

For example, in some embodiments, the ratio of assembled particles to the volume of solution in the droplet might be adjusted to improve dispersion throughout the droplet for analysis and/or testing, while also providing an adequate number of particles for analysis and/or testing. For example, in example embodiments, this particular ratio may be one or more of a variety of number of assembled particles to volume of solution from about 20 assembled particles (e.g., paramagnetic, bar-coded beads) to about 300 assembled particles (e.g., paramagnetic, bar-coded beads) per microliter of solution, including 10, 20, 30, 40, 50, 60, 70, 80, 90, 100, 110, 120, 130, 140, 150, 200, 250, and 300 assembled particles (e.g., paramagnetic, bar-coded beads) per microliter of solution.

In some embodiments, it is beneficial to immobilize the droplet and/or components thereof (e.g., paramagnetic, bar-coded beads) for one or more steps in an assay. In some embodiments, as described above, immobilization of the droplets on the cartridge surface can be controlled by applying an electrical current (e.g., a direct electrical current) to a plurality of electrodes of the cartridge. In some embodiments, immobilization of the droplets on the cartridge surface can be controlled by the at least one magnet. In some example embodiments, the at least one magnet may be a permanent or semi-permanent magnet below or above one or more portions of the cartridge surface. In other embodiments, the at least one magnet may be an electric magnet configured to interact with the droplet and/or components thereof (e.g., paramagnetic, bar-coded beads) via a controller and/or other computing devices to create a programmable interaction along the fluidic path to promote assay protocols and subparts thereof.

In other examples, after one or more binding members have attached to the particles (e.g., paramagnetic, bar-coded beads), the solution surrounding the particles may be removed and the particles with attached binding members (collectively referred to herein as “assembled particles”) may be washed in preparation for testing. In an example embodiment, during this washing portion, one or more components may be used to facilitate the washing, including one or more components of a cartridge to manipulate (e.g., immobilize) the assembled particles in one or more portions of the cartridge. For example, because the assembled particles may have magnetic or paramagnetic properties, an electrical current and/or a magnet may be used to secure the assembled particles in a portion of the cartridge while a washing solution is dispersed into the cartridge to improve the results of the washing portion (e.g., by ensuring that the assembled particles remain intact and in a specific portion of the cartridge). Other improvements may be realized.

In this regard, by combining the cartridge, EWOD, magnetic, and particle (e.g., paramagnetic, bar-coded bead technologies), the concepts described herein provide disclosure for a compact, in clinic, instrument with multiplex capability that allow the mixing and manipulation of solutions, samples, and particles (including paramagnetic, bar-coded beads) on the surface of the cartridge. In an example embodiment, by leveraging these technologies, a platform is described that can have the same convenience as other tabletop devices (e.g., a SNAP® reader and device) but with the increased menu of capabilities for laboratory testing and assay protocols, including multi-part assays (e.g., multiplex, Mpx lab tests), without the inconvenience and costs of the devices, instruments, and operators typically required for these tests and assays (e.g., liquid handling robots, plates, plate washers, and/or specialized plate readers). Further, in example embodiments, because multiple tests and assays may be completed on one or more small sample sizes (e.g., one or more droplets containing assembled paramagnetic, bar-coded beads), the present disclosure allows complex analysis (e.g., of multiple analytes) based on small volumes of samples, which is beneficial in instances where sample volume is an issue.

In one example, a user may add a sample (e.g., a fecal sample, urine sample, blood sample, etc.) into a reservoir of the cartridge, insert a cartridge into a tabletop instrument/device, and allow the instrument/device to add and/or control other components (e.g., paramagnetic, bar-coded beads, solution, antibodies, etc.) on the cartridge, and analyze one or more components to provide one or more results to clinician, physician, and/or patient based on the same, all using the same sample, cartridge and instrument/device. Importantly, once the user inserts the cartridge into the tabletop instrument device, some (or all) of the fluidics, manipulation of the components in the cartridge (including the paramagnetic, bar-coded beads), and eventual reading of these components are all automated, controlled, and finely-tuned by program instructions executing on a computing device, all of which may be accomplished without user interaction or control.

By doing so, several benefits are realized, including users (e.g., clinicians) having the same high throughput/multiplexing capability of the traditional technologies without the required overhead of user controlling or coordinating every step of the process or the multitude of separate devices and components required to accomplish the tests and/or assays. Time to result would also be improved, instead of sending samples to a lab and waiting for a prolonged period of time for results (sometimes several days), users could have results in a matter of minutes, and all while using a single sample on a single cartridge in connection with a single device. This improved time to result also improves the ability for a treating physician and/or patient to receive results in a more timely manner (e.g., results could be shared with the patient during the visit) and make more timely decisions based thereon.

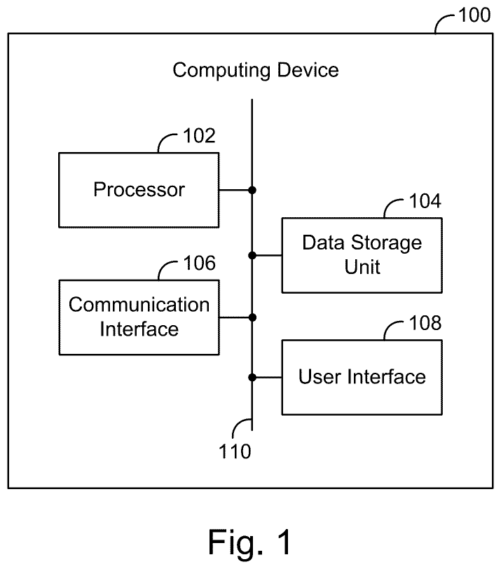

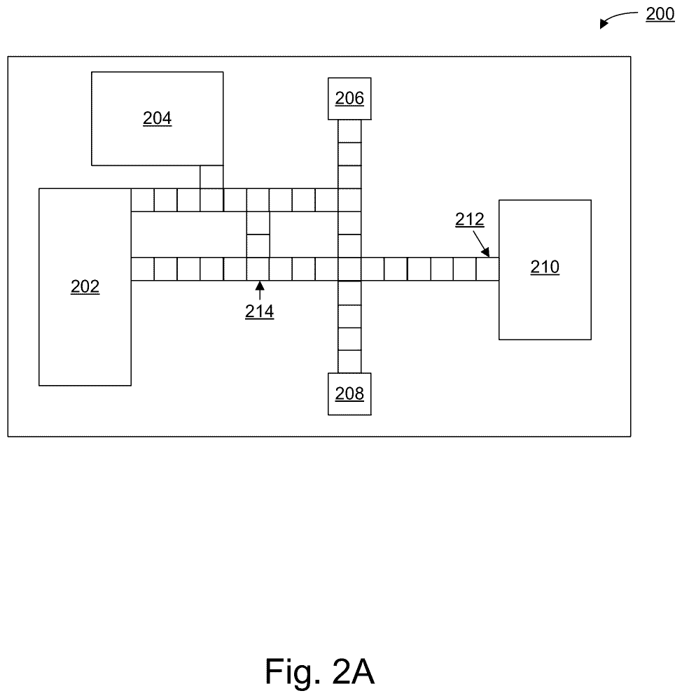

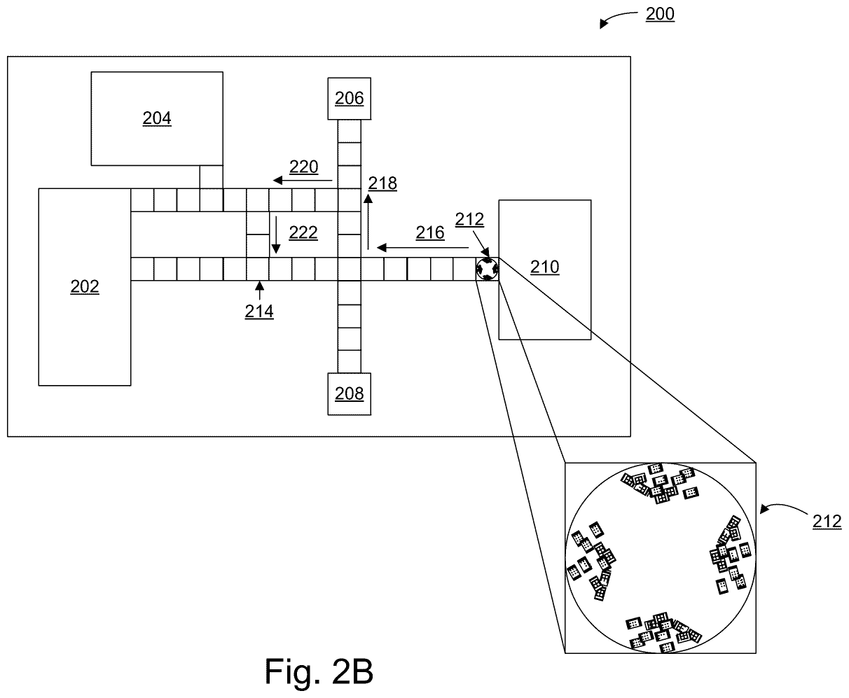

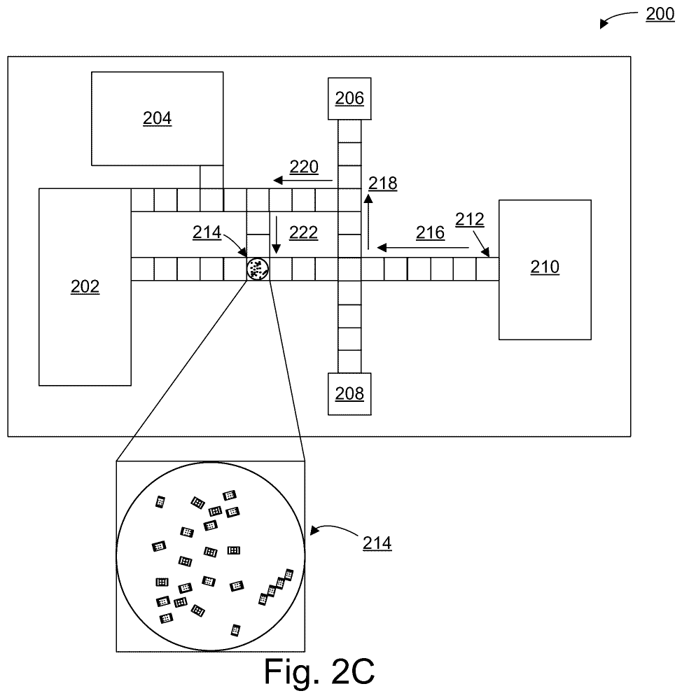

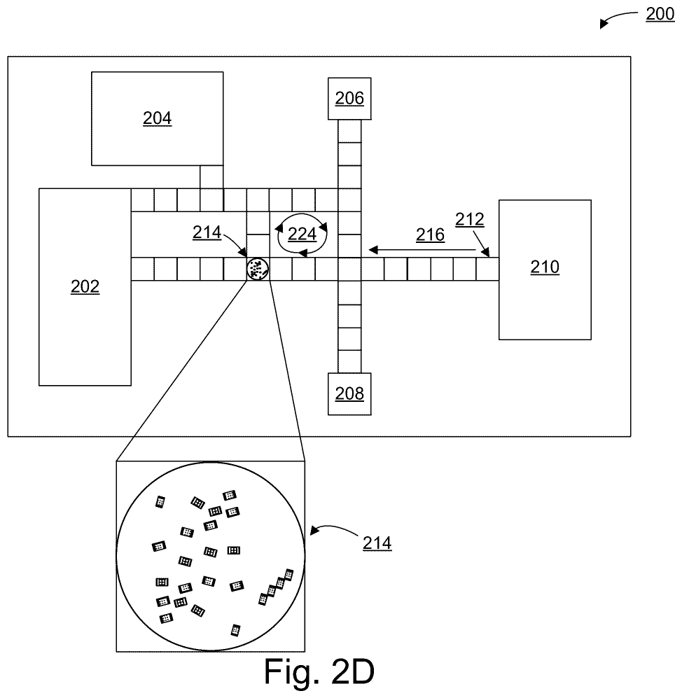

Referring now to the figures, FIG. 1 is a simplified block diagram of an example computing device 100 of a system (e.g., those illustrated in FIG. 2, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor) and/or a special-purpose processor (e.g., a digital signal processor (DSP)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI FI interface. In this disclosure, a connection can be a direct connection or an indirect connection, the latter being a connection that passes through and/or traverses one or more entities, such as such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Now referring to FIG. 2A, a cartridge 200 is disclosed, which includes a sample reservoir 202, a solution reservoir 204, a particle reservoir 206, an assay component reservoir 208, and a waste reservoir 210 that reside on a dielectric cartridge surface, which according to the illustrated example embodiment, also comprises an assembly location 212 and a testing location 214. In this example embodiment, one or more sets of a plurality of electrodes are disposed along various portions of dielectric cartridge surface, including in the illustrated plurality of paths that connect assembly location 212 and testing location 214, as well as sample reservoir 202, solution reservoir 204, particle reservoir 206, assay component reservoir 208, and waste reservoir 210. As illustrated in FIG. 2A (and FIGS. 2B-2D), the plurality of paths (and the underlying plurality of electrodes) are shown as the series of illustrated small squares that that connect assembly location 212 and testing location 214, as well as sample reservoir 202, solution reservoir 204, particle reservoir 206, assay component reservoir 208, and waste reservoir 210.

As noted above, this plurality of electrodes facilitates transportation and manipulation of a fluid droplet containing a plurality of particles (e.g., a plurality of paramagnetic, bar-coded beads) along dielectric cartridge surface of cartridge 200. For clarity, as illustrated in FIG. 2A (and FIGS. 2B-2D), the term “dielectric cartridge surface” as used in FIG. 2A (and FIGS. 2B-2D) includes the cartridge surfaces below the illustrated assembly location 212 and testing location 214, as well as sample reservoir 202, solution reservoir 204, particle reservoir 206, assay component reservoir 208, and waste reservoir 210, as well as the illustrated paths that connects all of these components in FIGS. 2A-2D.

In examples, the cartridge 200 and/or any components thereof may interact with a computing device, such as computing device 100. As described above, a computing device 100 can be implemented as a controller, and a user of the controller can use the controller to program and/or control cartridge 200 and/or any components thereof. The cartridge 200 and/or any components thereof may communicably coupled with a controller, such as computing device 100, and may communicate with the controller by way of a wired connection, a wireless connection, or a combination thereof. Further, as described above, a controller may be configured to control various aspects of the illustrated cartridge 200 and testing protocols (e.g., assays) utilizing cartridge 200 and/or any components thereof. Although various cartridge components and arrangements of these components a are provided for explanatory purposes, and different shapes, amounts, and/or types of beads, particles, and/or components may be used.

In examples, the controller can execute a program that cause one or more components of the cartridge 200 to perform a series of events by way of a non-transitory computer-readable medium having stored program instructions. These program instructions include, for example, applying voltage and/or current to a plurality of electrodes near (e.g., below) the dielectric materials of dielectric cartridge surface to manipulate one or more droplets (or components thereof) along the dielectric cartridge surface, including along the illustrated plurality of paths that connect assembly location 212 and testing location 214, as well as sample reservoir 202, solution reservoir 204, particle reservoir 206, assay component reservoir 208, and waste reservoir 210. In some examples, the plurality of electrodes may be used to transport one or more droplets between the illustrated components of FIG. 2 and/or manipulate (e.g., immobilize) the one or more droplets and/or components thereof at one more locations of the dielectric cartridge surface.

For example, certain voltages/currents amplitudes and patterns, as well as electrode placement around the surface of the dielectric cartridge surface may more effectively agitate the droplet to produce more accurate and consistent mixing (e.g., of the plurality of particles throughout the droplet) and associated assay results than other methods. For example, the plurality of electrodes may receive a particular alternating electrical current at a particular frequency (e.g., 30 hertz) and/or voltage (e.g., 300 volts) that causes the droplet to be transported along the surface of the cartridge such that the droplet is moving at a particular transport speed such that the droplet does not reside in one location on the cartridge surface for more than a threshold amount of hold time (e.g., 200 milliseconds) during transportation. In examples, the controller may transport the droplet around the surface of the cartridge along one or more predefined paths, potentially a number of times, according to one or more of the parameters detailed above (e.g., at one or more of a particular voltage, frequency, transport speed, hold time, etc.). Further, the controller may transport the droplet around the surface of the cartridge via program instructions that include moving various fluids around the surface of the cartridge and perform various aspects of an assay, all on the surface of the cartridge and all in an automated (or largely automated) procedure.

In example embodiments, the plurality of electrodes may transport a droplet containing a plurality of particles on the dielectric cartridge surface along the illustrated plurality of paths that connect assembly location 212 and testing location 214, as well as sample reservoir 202, solution reservoir 204, particle reservoir 206, assay component reservoir 208, and waste reservoir 210. In examples, the plurality of particles (e.g., paramagnetic, bar-coded beads) may be introduced into a droplet, either in a liquid suspension or dried onto a surface of the cartridge 200 and rehydrated. In one example, the plurality of particles may be suspended in buffer solution containing sucrose, removed from the suspension, and dried before being stored in particle reservoir 206. In examples, the plurality of particles may be rehydrated with one or more solutions containing one or more components (e.g., reagents, sample, or both, among other possibilities) before being used in one or more aspects of an assay. In example embodiments, once the plurality of particles are rehydrated and/or introduced into a fluidic droplet, the droplet containing the plurality of particles may be transported from particle reservoir 206 to sample reservoir 202 to be mixed with a sample residing in sample reservoir (e.g., a fecal sample, urine sample, blood sample, etc.).

In a further aspect, in example embodiments, the plurality of electrodes may transport a droplet of assay components (e.g., containing antibodies, antigens, labels, and/or other binding members) on the dielectric cartridge surface. In examples, these assay components may be introduced into a droplet, either in a liquid suspension or dried onto a surface of the cartridge 200 and rehydrated. Either way, once the plurality of particles are introduced into the droplet, a droplet containing plurality of particles may be transported from assay component reservoir 208 to sample reservoir 202 to be mixed with a sample residing in sample reservoir. Furthermore, although assay component reservoir 208 is illustrated as a single reservoir in FIG. 2A, it should be apparent to a person of ordinary skill in the art that assay component reservoir 208 may comprise multiple, separate reservoirs, each of which may contain a particular assay components or combination thereof (e.g., a particular antibodies, antigens, labels, and/or other binding members). Additionally or alternatively, although specifically illustrated in FIG. 2A, there may be multiple assay component reservoirs in cartridge 200, each with their own associated assay component and/or path on the dielectric cartridge surface.

In example embodiments, a variety of techniques can be used facilitate the dispersion of the plurality of particles, other assay components and/or the sample within the droplet. In a further aspect, these techniques may also be used to further facilitate mixing the plurality of particles, other assay components and/or the sample (e.g., in the sample reservoir 202) at various mixing speeds, patterns, etc., all of which may be controlled by the controller executing program instructions controlling the components of the cartridge 200.

In example embodiments, once the droplet containing the plurality of particles (e.g., paramagnetic, bar-coded beads), the sample, and/or other assay components is sufficiently mixed, all of these components may incubate in the sample reservoir 202 (e.g., to allow attachment of one or more assay components and/or components of the sample to attach to the paramagnetic, bar-coded beads). In example embodiments, once the incubation is complete, the plurality of particles and the attached sample and/or assay components (collectively, the “assembled particles”) may be further manipulated in the sample reservoir 202 (e.g., immobilized using an electrical current and/or a magnet) and/or at the assembly location 212 (e.g., using a plurality of electrodes). Once at the assembly location 212, the fluids surrounding the plurality of particles and the attached sample and/or assay components may be removed and transported to waste reservoir 210 along dielectric cartridge surface.

In example embodiments, if the fluids are removed from the assembly location 212, a solution (e.g., a washing solution) may be transported from solution reservoir 204 to assembly location 212 to wash excess debris and/or other components from the assembled particles. In example embodiments, this solution may interact with the assembled particles based on fluidics controlled by the plurality of electrodes transporting the solution fluid over immobilized assembled particles, or via a mixing protocol with the assembled particles (such as the mixing steps described above). Once the excess debris and/or other components are washed from the assembled particles, the solution (and any other excess fluids) may be transported from assembly location 212 to waste reservoir 210 along dielectric cartridge surface (e.g., using a plurality of electrodes), as the assembled particles remain at the assembly location 212 (e.g., via immobilization).

In a further aspect, although the mixing protocols have been discussed in connection with sample reservoir 202 and assembly location 212, it should be appreciated that these mixing protocols can occur in other parts of the illustrated cartridge 200, including dielectric cartridge surface portion. Other examples are possible.

Once the assembled particles are completed and ready for analysis, in example embodiments, the assembled particles may be transported to a portion of the cartridge for analysis, including testing location 214. Prior to analyzing the assembled particles, one of several steps may undertaken to improve the accuracy and precision of the analysis.

In example embodiments, the assembled particles may be disposed in a liquid (e.g., a solution from solution reservoir 204) and transported via fluidic transportation across the dielectric cartridge surface, via a plurality of electrodes (i.e., moving the assembled particles along one or more paths of the dielectric cartridge surface), among other possibilities.

Now referring to FIG. 2B, cartridge 200 is illustrated with a plurality of assembled particles in a droplet residing on the dielectric cartridge surface at assembly location 212. As illustrated in FIG. 2B, the assembled particles have moved to the perimeter of the droplet and are not evenly distributed throughout the droplet of solution (e.g. because of clumping, binding/settling on the bottom or sides of the droplet, etc.). To help improve the dispersion and consistency of particles in the droplet of solution, the droplets and/or or components thereof may be transported along one or more specific paths on the surface of the cartridge 200. As illustrated in FIG. 2B, these paths may include a first path 216, a second path 218, a third path 220, and fourth path 222, which allow a plurality of electrodes to transport the droplet and assembled particles residing at assembly location 212 to testing location 214. As illustrated in FIG. 2B, a plurality of electrodes may cause the droplet to be transported along first path 216 (in the direction indicated by the arrow above first path 216) at a particular transport speed and then cause the droplet be transported along second path 218 (in the direction indicated by the arrow to the right of second path 218) at the same transport speed. As illustrated in in FIG. 2B, because first path 216 is perpendicular to second path 218, because the transport speed of the droplet is maintained when the droplet travels along both first path 216 and second path 218, the kinetics of being transported along the first and second paths impart a mechanical action on the droplet and/or the components thereof during transportation of the droplet (e.g., caused by the momentum of the droplet and/or the components taking a 90 degree turn during transportation). In a further aspect, if this transport speed is maintained as the droplet is transported along third path 220 (in the direction indicated by the arrow above third path 220) and fourth path 222 (in the direction indicated by the arrow to the right of fourth path 222), then the kinetics of being transported along the third and fourth paths impart an additional two mechanical actions on the droplet and/or the components thereof during transportation of the droplet (e.g., caused by the momentum of the droplet and/or the components taking a 90 degree turn between the second and third paths and the third and fourth paths during transportation). These mechanical actions may cause, among other things, the components of the droplet (e.g., a plurality of particles in the droplet) to move and/or otherwise disperse throughout the droplet. Other examples are possible.

For example, in some example embodiments, as the droplet is transported along these paths, the electrical current applied to the plurality of electrodes to transport the droplet may also be used to manipulate the droplets and/or or components thereof at one or more locations along the fluidic paths on the surface of the cartridge. In some examples, during transportation along the paths illustrated in FIG. 2B, the plurality of electrodes may receive an alternating electrical current at a particular frequency during transportation of the droplet, which may cause the droplet and/or components therein (e.g., assembled particles) to further disperse and/or otherwise move within the droplet-particularly if the assembled particles have a magnetic property (e.g., paramagnetic, bar-coded beads). In some examples, the plurality of electrodes may also receive the alternating electrical current at a particular voltage during transportation, which may also cause the droplet and/or components therein (e.g., assembled particles) to further disperse and/or otherwise move within the droplet.

Now referring to FIG. 2C, cartridge 200 is illustrated with a plurality of assembled particles in a droplet that has been transported from assembly location 212 to testing location 214 via first path 216, second path 218, third path 220, and fourth path 222. As illustrated in FIG. 2C, the assembled particles have moved away from the perimeter of the droplet and are primarily evenly distributed throughout the droplet of solution. As compared to the illustrated droplet of FIG. 2B, the droplet illustrated in FIG. 2C has improved dispersion and consistency of particles in the droplet of solution, as the droplet and/or or components thereof have been transported along first path 216, second path 218, third path 220, and fourth path 222 of the cartridge 200 and the kinetics of being transported along these paths at one or more particular transport speeds and according to one or more parameters of the plurality of electrodes (e.g., a particular AC with a particular frequency and/or voltage), one or more mechanical actions have been imparted to the droplet and/or the components thereof during transportation of the droplet and caused, among other things, the components of the droplet to move and/or otherwise disperse throughout the droplet.

In a further aspect, once the droplet and the plurality of particles reach the testing location 214, one or more additional mechanical actions may be taken on the droplet and/or the components therein, including the assembled particles. For example, the droplets and/or or components thereof may be manipulated and/or otherwise controlled by a plurality of electrodes that receive an electrical current that manipulates (e.g., immobilizes) the droplet. In some examples, the plurality of electrodes may receive a direct electrical current (“DC”) that immobilizes the droplet and/or the components thereof at testing location 214 during testing and/or analysis. In some examples, particularly if the droplet and/or the components thereof have magnetic or paramagnetic properties, if plurality of electrodes in or around testing location 214 receive a direct electrical current, then the droplet and/or the components may align and/or otherwise be oriented in one or more particular orientations (e.g., due to the DC creating a magnetic field in one or more particular directions). Other examples are possible.

Now referring to FIG. 2D, cartridge 200 is illustrated with a plurality of assembled particles in a droplet residing on the dielectric cartridge surface at testing location 214. As illustrated in FIG. 2D, to help improve the dispersion and consistency of particles in the droplet of solution, the droplets and/or or components have been transported along two paths, including a first path 216 and a rectangular path 224, which allow a plurality of electrodes to transport the droplet and assembled particles residing at assembly location 212 to testing location 214. As illustrated in FIG. 2D, a plurality of electrodes cause the droplet to be transported along first path 216 at a particular transport speed and then cause the droplet to be transported along rectangular path 224 (in the direction indicated by the arrow in the middle of rectangular path 224) at the same transport speed. As illustrated in in FIG. 2D, because first path 216 is perpendicular to portions of rectangular path 224 and the rectangular path forms a closed path for the droplet to travel around (potentially several times), because the transport speed of the droplet is maintained when the droplet travels along both first path 216 and rectangular path 224, the kinetics of being transported along the first and rectangular paths impart a mechanical action on the droplet and/or the components thereof during transportation of the droplet (e.g., caused by the momentum of the droplet and/or the components taking several 90 degree turns during transportation around rectangular path 224). In a further aspect, if this transport speed is maintained as the droplet is transported along third path 220 (in the direction indicated by the arrow above third path 220) and fourth path 222 (in the direction indicated by the arrow to the right of fourth path 222), then the kinetics of being transported along the third and fourth paths impart an additional two mechanical actions on the droplet and/or the components thereof during transportation of the droplet (e.g., caused by the momentum of the droplet and/or the components taking a 90 degree turn between the second and third paths and the third and fourth paths during transportation). These mechanical actions may cause, among other things, the components of the droplet (e.g., a plurality of particles in the droplet) to move and/or otherwise disperse throughout the droplet. Further, although rectangular path 224 is illustrated in FIG. 2D as a rectangle, other example non-linear paths are possible, including: substantially square paths, substantially circular paths, substantially triangular paths, substantially pentagonal paths, substantially hexagonal paths, substantially heptagonal paths, substantially octagonal paths, and substantially decagonal paths, among others. Other examples are possible.

For example, during transportation along the paths illustrated in FIG. 2D, the plurality of electrodes may receive an alternating electrical current at a particular frequency during transportation of the droplet, which may cause the droplet and/or components therein (e.g., assembled particles) to further disperse and/or otherwise move within the droplet-particularly if the assembled particles have a magnetic property (e.g., paramagnetic, bar-coded beads). In some examples, the plurality of electrodes may also receive the alternating electrical current at a particular voltage during transportation, which may also cause the droplet and/or components therein (e.g., assembled particles) to further disperse and/or otherwise move within the droplet.

Furthermore, once the droplet and the plurality of particles reach the testing location 214 in FIG. 2D, as discussed above, one or more additional mechanical actions may be taken on the droplet and/or the components therein including that the plurality of electrodes may receive a direct electrical current (“DC”) that immobilizes and/or otherwise manipulates the droplet and/or the components thereof at testing location 214 during testing and/or analysis-particularly if the droplet and/or the components thereof have magnetic or paramagnetic properties, (e.g., due to the DC creating a magnetic field in one or more particular directions). Other examples are possible.

In examples, testing location 214 provides a predetermined location for a reader to conduct the analysis and/or testing (e.g., assay testing) on the assembled particles. In example embodiments, the reader may detect, shortly after the assembled particles arrive at the testing location 214, an assay read signal corresponding to at least one of the assembled particles at the testing location 214. In some example embodiments, this detection and/or analysis may occur within a predetermined time period after the assembled particles arrive at the testing location 214 and any manipulation (e.g., immobilization) has been undertaken. For example, in an example embodiment, once the droplet arrives at the testing location 214 after any one or more of the transportation protocols described above, a direct electrical current may be applied to the plurality of electrodes under or around the testing location 214 for a predetermined amount of time prior to testing and/or analysis. For example, the droplets containing the assembled particles may be immobilized and/or otherwise manipulated by the plurality of electrodes (e.g., via direct electrical current at 300 volts) for a threshold amount of time (e.g., 5000 milliseconds) prior to analysis. Other examples are possible.

In an example embodiment, during analysis, one or more cameras and./or an optics system reader may be employed to capture images of the assembled particles and/or decode properties of these particles (e.g., decoding the individual bar codes of the paramagnetic, bar-coded beads). In other examples, a plurality of electrodes and/or one or more magnets may be used to manipulate the paramagnetic, bar-coded beads while reading other parameters of the droplet containing the assembled particles and/or the assembled particles themselves (e.g., by applying an ultraviolet light and reading the fluorescence of the assembled particles via a fluorophore detector). As illustrated in FIGS. 2C and 2D, exploded views of testing location 214 provide an example view of paramagnetic, bar-coded beads, and it should be appreciated that this analysis (e.g., reading) could occur at other portions of the cartridge 200, including along other location of the paths and/or other dielectric cartridge surface portions of the cartridge 200.

For example, to help measure the dispersion and consistency of the assembled particles in the droplet solution, an image of the droplet of solution may be generated. In examples, this image may contain a plurality of images of the droplet of solution and based on one or more attributes of this generated image, one or more parameters may be determined for the droplet and/or the components thereof.

For example, the generated image may also be used to identify one or more characteristics of the individual particles in the droplet. For example, if the particles include paramagnetic beads that include one or more unique bar codes, the generated image may be used to identify one or more unique bar codes in the image corresponding to the individual particles in the transferred aliquot of solution. In example embodiments, the one or more unique bar codes identified in the generated image can also be used to determine an assay result. In example embodiments, the one or more unique bar codes identified in the generated image can also be compared to an assay result generated from another source (e.g., a reader) and/or used to determine the accuracy of the results from another source (e.g., by comparing the assay results from the reader to those determined from the generated image).

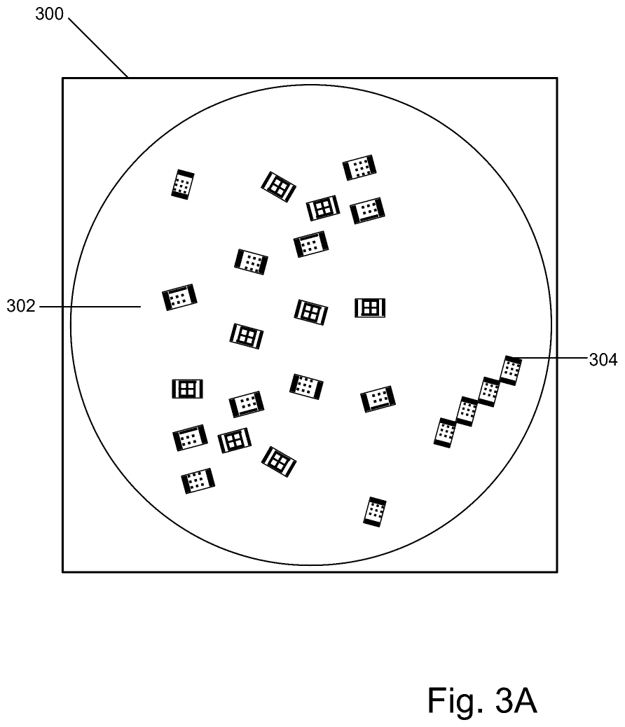

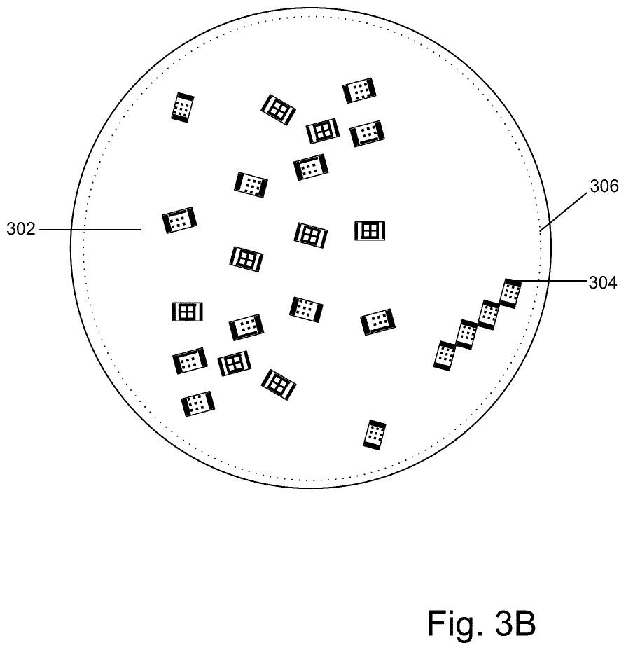

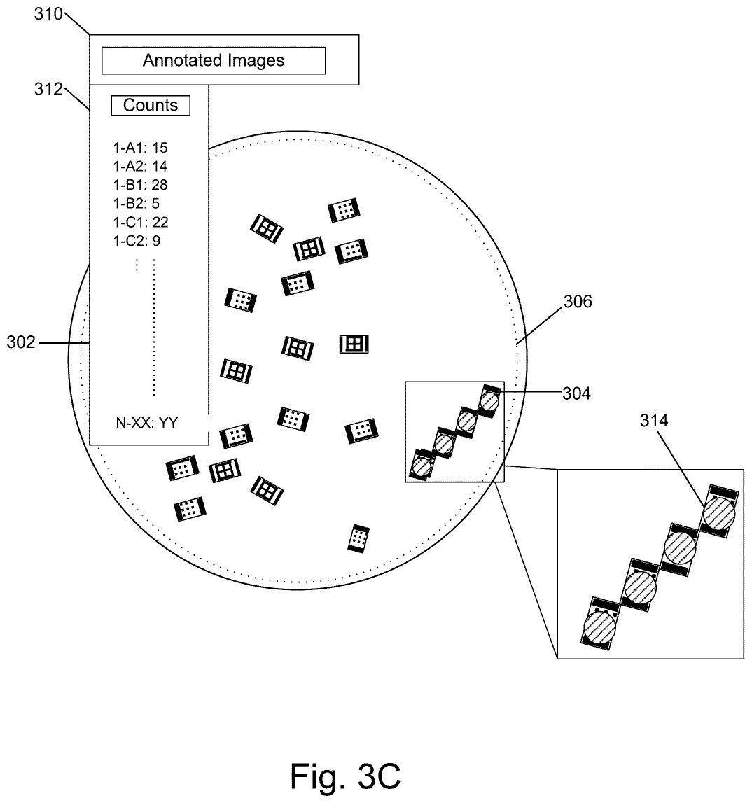

In FIGS. 3A-3C, a sample image 300 of a section of the dielectric surface of a cartridge (the square represents one or more components of the dielectric surface, including the plurality of electrodes) that resides under a droplet of solution 302 containing particles is illustrated according to an example embodiment. These particles may be utilized during one or more assay procedures, including, for example, to identify a particular type and/or subset of components within a sample. In the example embodiment illustrated in FIGS. 3A-3C, the solution droplet 302 includes assembled particles 304. In some example embodiments, each of the assembled particles 304 includes a unique bar code. In another example, each of the assembled particles 304 includes two or more unique bar codes.

In yet another example, a subset of the assembled particles 304 may include one unique bar code and the remaining assembled particles 304 may include two or more unique bar codes. In practice, each of these bar codes may correspond to particular information about the paramagnetic bead, the droplet of solution, and/or one or more additional parameters (including those used in an assay). For example, these unique bar codes may be utilized during one or more assay procedures to identify a particular type and/or subset of paramagnetic beads within the solution.

It should also be noted that although the particles illustrated in FIGS. 3A-3C involve paramagnetic beads, different shapes, amounts, and/or types of particles may be used.

It should also be noted that one or more concepts illustrated in FIGS. 3A-3C may be accomplished using a computing device, such as computing device 100. As described above, a computing device 100 can be implemented as a controller, and a user of the controller can use the controller to control the capturing of one or more images of the droplet of solution, as well as process the plurality of images to generate and/or annotate one or more images of the plurality of images.

In examples, the controller can execute a program that causes the controller and/or components operating therewith (e.g., a camera) to perform a series of actions by way of a non-transitory computer-readable medium having stored program instructions.

In FIG. 3A, a sample image 300 of the prepared droplet of solution on a surface of a cartridge (e.g., cartridge 200) is illustrated, wherein the prepared droplet of solution comprises a plurality of particles (e.g., assembled particles). In 3A, the sample image 300 includes portions of the surface of the cartridge (which may include images of a dielectric surface and/or a plurality of electrodes, etc.), as well as the droplet 302 and the assembled particles 304 (e.g., paramagnetic beads).

Turning to FIG. 3B, an example processed image of sample image 300 is illustrated. In FIG. 3B, portions of the surface of the cartridge have been removed and processing 306 has been added, in which the sample image 300 has been divided into four quadrants for image processing. In example embodiments, further annotation and/or analysis of the illustrated surface may include different sizes, shapes, numbers, and configurations of portions to be imaged for the droplet of solution, depending on one or more characteristics of the sample (e.g., one or more bar codes of the particles, particle size, particle concentration, etc.) and/or the image analysis to be undertaken. Once the processing 306 is completed, one or more images may be processed (e.g., cropped, resized, adjusted brightness, adjusted saturation, etc.) before further processing.

Turning to FIG. 3C, an example processed image 310 is provided. In example embodiments, the controller may determine which images in the plurality of images of the droplet of solution that contain particles by performing one or more of a pixel density and/or gradient analysis of the individual images captured by the controller. In some example embodiments, the particles in the droplet of solution (e.g., assembled particles 304) may present a different contrast and/or pixel density compared the solution in which the particles are disposed (shown in FIGS. 3A-3C as the dark, black portions of assembled particles 304 compared to the light, white portions of the surround solution of droplet 302). Other examples are possible.

Once processed image 310 has been generated, further analysis may be undertaken on the composite image 310 to determine one or more parameters of the droplet of solution and/or the particles contained therein. In example embodiments, the controller may use one or more algorithms (including Harris corner detection) and/or protocols to detect an edge of a particle in the composite image, based at least in part on detecting an edge of the particle in the composite image, determining a presence of at least one particle in the image. Other examples, including the use of other image processing and/or machine learning and artificial intelligence algorithms, are possible. For example, one or more machine learning models may comprise a deep learning model and/or image pixel and/or gradient analysis models.

In example embodiments, the controller may determine the count of the particles in the droplet of solution by identifying the particles in the solution and generate annotated image 314 by utilizing one or more edge detection protocols (including the Harris corner detection algorithm). In example embodiments, the controller may perform this edge detection for the particles in the solution, generate a count of the particles in the solution, and present annotated images of the particles identified and/or counted in the annotated image of FIG. 3C. For example, as shown in example graphical user interface of FIG. 3C, in example embodiments, the controller may present the user with an image accounting 312 of all of the attributes of the generated image and/or associated protocol (e.g., how many particles were identified in the generated image of sample and/or corresponding images). Other examples are possible.

Further, in example embodiments, once the annotated image has been generated, further actions may be undertaken on the annotated image to further inform a user of the controller of one or more parameters of the droplet of solution and/or the particles contained therein. In example embodiments, as shown in the example graphical user interface of FIG. 3C, a user may be presented with an annotated version of a one or more particles in the solution, as well an annotated version of a multiple particles that may be overlapping and/or joined together in the solution. In example embodiments, the user may select to generate one or more additional annotated images and/or graphical user interfaces based on the annotated image, including total particle counts in the sample, the types of particles in the sample, and the extent of overlapping particles in the sample, as well as results of the assay itself.

### EXAMPLE METHODS AND ASPECTS

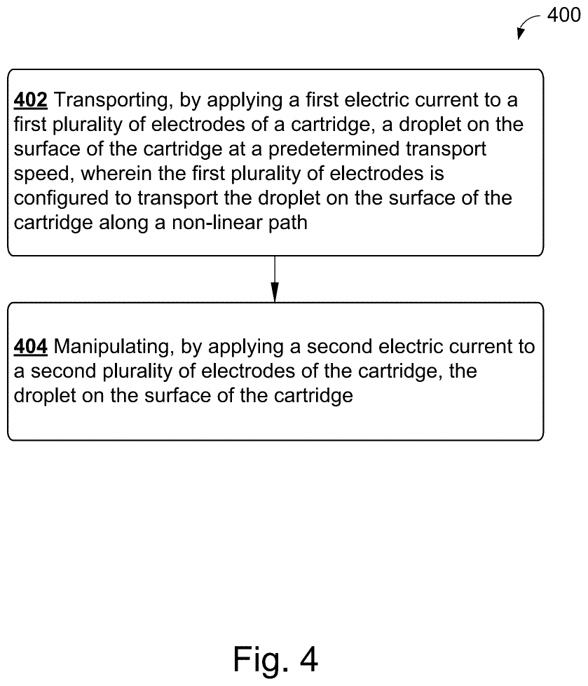

Now referring to FIG. 4, an example method of dispersing a plurality of particles of a droplet on a surface of a cartridge is disclosed.

Method 400 shown in FIG. 4 presents an example of a method that could be used with the components shown in FIGS. 1-3C, for example. Further, devices or systems may be used or configured to perform logical functions presented in FIG. 4. In other examples, components of the devices and/or systems may be arranged to be adapted to, capable of, or suited for performing the functions, such as when operated in a specific manner. Method 400 may include one or more operations, functions, or actions as illustrated by one or more of blocks 402-404. Although the blocks are illustrated in a sequential order, these blocks may also be performed in parallel, and/or in a different order than those described herein.

Also, the various blocks may be combined into fewer blocks, divided into additional blocks, and/or removed based upon the desired implementation.

At block 402, method 400 involves transporting, by applying a first electrical current to a first plurality of electrodes of the cartridge, the droplet on the surface of the cartridge at a predetermined transport speed, wherein the first plurality of electrodes is configured to transport the droplet on the surface of the cartridge along a non-linear path.

In some example embodiments, the plurality of particles comprises at least one paramagnetic, bar-coded bead. In some embodiments, the at least one paramagnetic, bar-coded bead of the droplet comprises one or more unique bar codes. In other examples, the at least one paramagnetic, bar-coded bead of the droplet comprises at least one non-spherical, paramagnetic, bar-coded bead. In other examples, the at least one paramagnetic, bar-coded bead of the droplet comprises at least one spherical, paramagnetic, bar-coded bead. In some examples, the at least one paramagnetic, bar-coded bead of the droplet is between approximately 0.1 and 100 microns in size. In some examples, the droplet further comprises a solution for washing the at least one paramagnetic, bar-coded bead of the droplet. In some examples, the droplet further comprises a read buffer solution.

In some examples, the surface of the cartridge comprises a dielectric material, and transporting, via a plurality of electrodes of the cartridge, the droplet on the surface of the cartridge comprises applying an electrical current to the electrodes of the cartridge. In some examples, the first electrical current comprises an alternating electrical current. In some examples, the first electrical current comprises an alternating electrical current of approximately 30 hertz. In some examples, the first electrical current comprises a voltage of approximately 300 volts. In some examples, the first electrical current comprises a direct electrical current.

In some examples, the transport speed comprises a transport speed of approximately 200 millisecond hold time. In some examples, the transport speed comprises a transport speed of less than 200 millisecond hold time.

In some examples, the non-linear path comprises a first path and a second path, and the first path is a substantially linear path and the second path is a substantially linear path that intersects with and is perpendicular to the first path. In some examples, the non-linear path comprises a first path and a second path, and the first path is a substantially linear path and the second path is a substantially rectangular path that intersects with the first path. In some examples, transporting the droplet on the surface of the cartridge along a non-linear path comprises transporting the droplet along at least one of the first path and the second path of the non-linear path a plurality of times.

At block 404, method 400 involves manipulating, by applying a second electrical current to a second plurality of electrodes of the cartridge, the droplet on the surface of the cartridge.

In some examples, the second electrical current comprises a direct electrical current. In some examples, the second electrical current comprises a direct electrical current with a voltage of approximately 300 volts. In some examples, the first electrical current comprises an alternating electrical current.

In some examples, manipulating, by applying a second electric current to a second plurality of electrodes of the cartridge, the droplet on the surface of the cartridge comprises immobilizing, the droplet on the surface of the cartridge, and wherein immobilizing the droplet on the surface of the cartridge comprises applying a direct electric current to the second plurality of electrodes of the cartridge, and wherein the direct electric current comprises a voltage of approximately 300 volts.

Additionally, in some examples, the method 400 further includes analyzing, while the droplet is transported or immobilized on the surface of the cartridge, the droplet. In some examples, analyzing the droplet comprises performing one or more assay procedures on the droplet, and wherein, during the one or more assay procedures, determining a parameter of the droplet. In some examples, determining a parameter of the droplet comprises identifying a particular feature of the plurality of particles of the droplet, and wherein the plurality of particles comprises at least one paramagnetic, bar-coded bead. In other examples, determining a parameter of the droplet comprises identifying a particular feature of the at least one paramagnetic, bar-coded bead of the droplet.

In some examples, analyzing the droplet comprises generating an image of the droplet on the surface of the cartridge, wherein the image comprises an image of the plurality of particles of the droplet, and wherein the plurality of particles comprises at least one paramagnetic, bar-coded bead and, based on the generated image, determining a parameter of the droplet. In some examples, determining a parameter of the droplet comprises comparing the generated image of the droplet to a previously generated image of the droplet. In some examples, analyzing the droplet further comprises, while generating an image of the droplet on the surface of the cartridge, applying at least one of a fluorescent and an ultraviolet light to the droplet. In some examples, analyzing the droplet comprises generating a composite image of the droplet on the surface of the cartridge, wherein the composite image comprises a plurality of images of the at least one paramagnetic, bar-coded bead of the droplet and, based on the generated composite image, determining a parameter of the droplet. In some examples, the method 400 includes transmitting instructions that cause a graphical user interface to display a graphical representation of the determined parameter of the droplet. In some examples, analyzing the droplet comprises performing a plurality of assay procedures on the droplet, and wherein, during the one or more assay procedures, determining the presence of one or more analytes adhered to the plurality of particles of the droplet, and wherein the plurality of particles comprises at least one paramagnetic, bar-coded bead.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A method for dispersing a plurality of particles of a droplet on a surface of a cartridge, the method comprising:
transporting, by applying a first electrical current to a first plurality of electrodes of the cartridge, the droplet on the surface of the cartridge at a predetermined transport speed, wherein the first plurality of electrodes is configured to transport the droplet on the surface of the cartridge along a non-linear path; and
manipulating, by applying a second electrical current to a second plurality of electrodes of the cartridge, the droplet on the surface of the cartridge.

2. The method of claim 1, wherein the plurality of particles comprises at least one paramagnetic, bar-coded bead.

3. The method of claim 2, wherein the at least one paramagnetic, bar-coded bead of the droplet comprises one or more unique bar codes.

4. The method of claim 2, wherein the at least one paramagnetic, bar-coded bead of the droplet comprises at least one non-spherical, paramagnetic, bar-coded bead.

5. The method of claim 2, wherein the at least one paramagnetic, bar-coded bead of the droplet comprises at least one spherical, paramagnetic, bar-coded bead.

6. The method of claim 2, wherein the at least one paramagnetic, bar-coded bead of the droplet is between approximately 0.1 to 100 microns in size.

7. The method of claim 1, wherein the surface of the cartridge comprises a dielectric material.

8. The method of claim 1, wherein the first electrical current comprises at least one of: (i) a direct electrical current; and (ii) an alternating electrical current.

9. The method of claim 8, wherein the first electrical current comprises an alternating electrical current of approximately 30 hertz.

10. The method of claim 8, wherein the first electrical current comprises a voltage of approximately 300 volts.

11. The method of claim 1, wherein the transport speed comprises a transport speed of approximately 200 millisecond hold time.

12. The method of claim 1, wherein the transport speed comprises a transport speed of less than 200 millisecond hold time.

13. The method of claim 1, wherein the non-linear path comprises a first path and a second path, and wherein the first path is a substantially linear path and the second path is a substantially linear path that intersects with and is perpendicular to the first path.

14. The method of claim 13, wherein transporting the droplet on the surface of the cartridge along a non-linear path comprises transporting the droplet along at least one of the first path and the second path of the non-linear path a plurality of times.

15. The method of claim 1, wherein the non-linear path comprises a first path and a second path, and wherein the first path is a substantially linear path and the second path is a substantially rectangular path that intersects with the first path.

16. The method of claim 15, wherein transporting the droplet on the surface of the cartridge along a non-linear path comprises transporting the droplet along at least one of the first path and the second path of the non-linear path a plurality of times.

17. The method of claim 1, wherein the second electrical current comprises a direct electrical current.

18. The method of claim 1, wherein manipulating, by applying a second electrical current to a second plurality of electrodes of the cartridge, the droplet on the surface of the cartridge comprises immobilizing, the droplet on the surface of the cartridge, and wherein immobilizing the droplet on the surface of the cartridge comprises applying a direct electrical current to the second plurality of electrodes of the cartridge, and wherein the direct electrical current comprises a voltage of approximately 300 volts.

19. The method of claim 1, wherein the second electrical current comprises an alternating electrical current.

20. The method of claim 1, wherein the method further comprises analyzing the droplet while the droplet is transported or manipulated on the surface of the cartridge.

21. The method of claim 20, wherein analyzing the droplet comprises performing one or more assay procedures on the droplet, and wherein, during the one or more assay procedures, determining a parameter of the droplet.

22. The method of claim 21, wherein determining a parameter of the droplet comprises identifying a particular feature of the plurality of particles of the droplet.

23. The method of claim 22, wherein analyzing the droplet comprises generating an image of the droplet on the surface of the cartridge, wherein the image comprises an image of the plurality of particles of the droplet, and wherein the plurality of particles comprises at least one paramagnetic, bar-coded bead; and
based on the generated image, determining a parameter of the droplet.

24. The method of claim 23, wherein determining a parameter of the droplet comprises comparing the generated image of the droplet to a previously generated image of the droplet.

25. The method of claim 23, wherein analyzing the droplet further comprises, while generating an image of the droplet on the surface of the cartridge, applying at least one of a fluorescent and ultraviolet light to the droplet.

26. The method of claim 23, wherein the method further comprises:
transmitting instructions that cause a graphical user interface to display a graphical representation of the determined parameter of the droplet.

27. The method of claim 20, wherein analyzing the droplet comprises generating a composite image of the droplet on the surface of the cartridge, wherein the composite image comprises a plurality of images of the plurality of particles of the droplet, and wherein the plurality of particles comprises at least one paramagnetic, bar-coded bead; and
based on the generated composite image, determining a parameter of the droplet.

28. The method of claim 20, wherein analyzing the droplet comprises performing a plurality of assay procedures on the droplet, and wherein, during the one or more assay procedures, determining a presence of one or more analytes adhered to the plurality of particles of the droplet, and wherein the plurality of particles comprises at least one paramagnetic, bar-coded bead.

29. A non-transitory computer-readable medium, having stored thereon program instructions that, upon execution by a controller, cause a controller to perform a set of operations comprising:
transporting, by applying a first electrical current to a first plurality of electrodes of a cartridge, a droplet on a surface of the cartridge at a predetermined transport speed, wherein the first plurality of electrodes is configured to transport the droplet on the surface of the cartridge along a non-linear path, and wherein the droplet comprises a plurality of particles; and
manipulating, by applying a second electrical current to a second plurality of electrodes of the cartridge, the droplet on the surface of the cartridge.

30. A cartridge comprising:
a first plurality of electrodes;
a second plurality of electrodes;
a first surface for transporting, by applying a first electrical current to the first plurality of electrodes of the cartridge, a droplet on the surface of the cartridge at a predetermined transport speed, wherein the first plurality of electrodes is configured to transport the droplet on the surface of the cartridge along a non-linear path, and wherein the droplet comprises a plurality of particles; and
a second surface for manipulating, by applying a second electrical current to a second plurality of electrodes of the cartridge, the droplet on the surface of the cartridge.
